(19) United States
(12) Patent Application Publication
(10) Pub. No.: US 2025/0159406 A1
(43) Pub. Date: May 15, 2025

(54) HEARING APPARATUS, CONTROL METHOD, AND PROGRAM

(71) Applicant: JVCKENWOOD Corporation, Yokohama-shi (JP)

(72) Inventors: Takayuki UCHIDA, Yokohama-shi (JP); Makoto ORYOJI, Yokohama-shi (JP); Kuniaki TAKACHI, Yokohama-shi (JP); Yoichi HARUKAWA, Yokohama-shi (JP); Toru KAIWA, Yokohama-shi (JP)

(21) Appl. No.: 19/025,641

(22) Filed: Jan. 16, 2025

Related U.S. Application Data
(63) Continuation of application No. PCT/JP2023/024826, filed on Jul. 4, 2023.

(30) Foreign Application Priority Data
Aug. 25, 2022 (JP) 2022-133856

(51) Int. Cl. H04R 3/00

(52) U.S. Cl. CPC H04R 3/00; H04R 2430/01

(57) ABSTRACT

A hearing apparatus can adjust the volume level of an output sound by using a plurality of volume steps. The hearing apparatus includes an acquisition unit configured to acquire a hearing level of a user, a setting unit configured to set a volume curve representing a relationship between the plurality of volume steps and the volume level according to the hearing level, and a volume adjusting unit configured to adjust the volume level based on the volume curve. The volume curve has a change point at a predetermined position and is defined in such a manner that inclinations of the volume curve before and after the change point are different from each other.

### CROSS REFERENCE TO RELATED APPLICATION

This application is based upon and claims the benefit of priority from International Patent Application No. PCT/JP2023/024826 filed on Jul. 4, 2023, which is based on Japanese patent application No. 2022-133856, filed on Aug. 25, 2022, the disclosure of which is incorporated herein in its entirety by reference.

### BACKGROUND

The present disclosure relates to a hearing apparatus, a control method, and a program.

A technology for adjusting the volume level of sounds output from a sound output apparatus according to the hearing level of a user has been known. As related art, Patent Literature 1 discloses a telephone that estimates the hearing level of a talker and automatically changes the volume level of sounds output from the receiver according to the estimated hearing level.

Further, as other related art, a technology in which sounds occurring around a sound collector or the like are collected and their sound signals are amplified, so that the sounds having a large volume are output has been known. The above-described technology is used, for example, in a voice receiver that collects sounds, e.g., voices in a conversation carried on around a user, amplifies the volume of the collected sounds to a large one, and outputs the amplified sounds from an earphone(s) worn by the user. The user can adjust the volume by using a predetermined operation button so that the sound output from the earphone(s) or the like has a desired volume.
Patent Literature 1: Japanese Unexamined Patent Application Publication No. 2021-002732

### SUMMARY

As the above-described voice receiver can be configured to have a wide range of volume levels, it is possible to adapt the voice receiver to users having various hearing levels. The range of volume levels is, for example, from 0 dB to 40 dB. It is assumed that, in the case where the volume is adjusted over such a wide range, it is possible to select the volume in an analog manner and in a stepless manner, i.e., a continuous manner, by using, for example, a volume knob. In this case, a user adjusts the volume by turning the volume knob as desired. In this way, the user can easily adjust the volume so that the output sound has a desired volume.

However, in recent years, because of the digitalization of apparatuses, it is assumed that the volume is adjusted in a digital manner, i.e., a stepwise manner, over a range of a large number of steps. Further, in some cases, the number of steps in the range over which the volume can be adjusted is only about ten. In such cases, for example, the volume is adjusted over a range of a large volume difference of 40 dB by using only ten steps, so the volume difference per one step is large. Therefore, when a user changes the volume step by one step, the magnitude of the change in the output sound is large, so it is difficult to make a fine adjustment.

Further, depending on the hearing level of a user, it may not be efficient to adjust the volume over a wide volume range as described above. For example, when a user is a person with normal hearing, a large volume level (e.g., 40 dB) is too loud for the user to endure. Therefore, such a user is unlikely to select this volume level. On the other hand, when a user is a person with impaired hearing, a small volume level (e.g., 5 dB) is too low to for the user to hear. Therefore, such a user may not recognize the change in the volume at this volume level.

Further, assume that the number of steps of the volume is increased (e.g., to 30 steps) so that the volume can be finely adjusted irrespective of the hearing level of the user. In such a case, the number of operations performed before a desired volume is obtained increases for some users, so that the volume cannot be easily adjusted. As described above, the related art has a problem that it is difficult to enable each of users having different hearing levels to easily adjust the volume.

A hearing apparatus according to an embodiment of the present disclosure is a hearing apparatus capable of adjusting a volume level of an output sound by using a plurality of volume steps, including:
an acquisition unit configured to acquire a hearing level of a user;
a setting unit configured to set a volume curve representing a relationship between the plurality of volume steps and the volume level according to the hearing level; and
a volume adjusting unit configured to adjust the volume level based on the volume curve, in which
the volume curve has a change point at a predetermined position and is defined in such a manner that inclinations of the volume curve before and after the change point are different from each other.

A control method according to an embodiment of the present disclosure is a method for controlling a hearing apparatus capable of adjusting a volume level of an output sound by using a plurality of volume steps, including:
an acquisition step of acquiring a hearing level of a user;
a setting step of setting a volume curve representing a relationship between the plurality of volume steps and the volume level according to the hearing level; and
a volume adjusting step of adjusting the volume level based on the volume curve, in which
the volume curve has a change point at a predetermined position and is defined in such a manner that inclinations of the volume curve before and after the change point are different from each other.

A program according to an embodiment of the present disclosure is a program for causing a computer to perform a method for controlling a hearing apparatus capable of adjusting a volume level of an output sound by using a plurality of volume steps, the method for controlling the hearing apparatus including:
an acquisition step of acquiring a hearing level of a user;
a setting step of setting a volume curve representing a relationship between the plurality of volume steps and the volume level according to the hearing level; and
a volume adjusting step of adjusting the volume level based on the volume curve, in which
the volume curve has a change point at a predetermined position and is defined in such a manner that inclinations of the volume curve before and after the change point are different from each other.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a hearing apparatus according to an embodiment;

FIG. 2 shows an example of volume curve information according to an embodiment;

FIG. 3 shows volume curve information according to an embodiment in a table format; and

FIG. 4 is a flowchart showing control processes performed by a hearing apparatus according to an embodiment.

### DETAILED DESCRIPTION

Embodiments according to the present disclosure will be described hereinafter in detail with reference to the drawings. The same reference numerals (or symbols) are assigned to the same or corresponding elements throughout the drawings. Redundant descriptions will be omitted as appropriate to clarify the explanation.

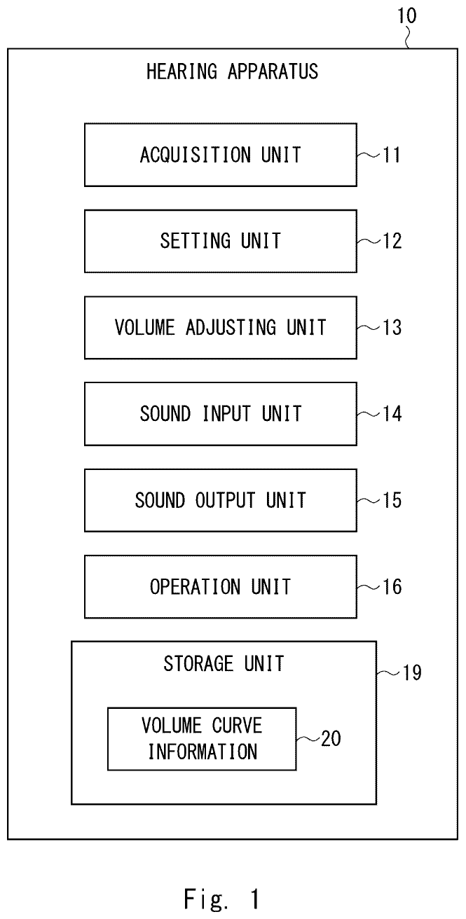

An embodiment according to the present disclosure will be described with reference to FIG. 1. FIG. 1 is a block diagram showing a configuration of a hearing apparatus 10 according to an embodiment of the present disclosure. As shown in FIG. 1, the hearing apparatus 10 includes an acquisition unit 11, a setting unit 12, a volume adjusting unit 13, a sound input unit 14, a sound output unit 15, an operation unit 16, and a storage unit 19.

### (Overview of Hearing Apparatus 10)

Firstly, an overview of the hearing apparatus 10 according to an embodiment of the present disclosure will be described. The hearing apparatus 10 is a hearing apparatus capable of adjusting the volume level of an output sound by using a plurality of volume steps. The hearing apparatus 10 is, for example, an acoustic device, e.g., a pair of acoustic devices, that a user can wear on his/her ear(s). An example of this embodiment, namely, a voice receiver that collects sounds, e.g., voices, occurring therearound, amplifies the collected sounds, and outputs the amplified sounds, will be described.

The hearing apparatus 10 typically includes an output unit for the right ear and one for the left ear. The sound input unit 14, the sound output unit 15, and the operation unit 16 are disposed on the outside of a housing that constitutes the output unit. The sound input unit 14 is, for example, a microphone and collects sounds, i.e., voices, in a conversation carried on around the user. The sound output unit 15 is, for example, a speaker, and amplifies the volume of the collected sounds and outputs the amplified sounds. The operation unit 16 is, for example, an operation button and receives an operation performed by the user.

The user puts the hearing apparatus 10 on his/her own ear(s), so that he/she can hear the sounds, e.g., voices, output from the sound output unit 15. Further, the user can also adjust the volume of the output sounds to a desired volume level by operating the operation unit 16.

The hearing apparatus 10 can be, for example, overhead-type headphones with a headband, or a canal-type or inner-ear type earphone(s). The hearing apparatus 10 may be a left-right separated type (completely wireless type) earphones of which left and right output units are independent of each other. Further, the hearing apparatus 10 may be left-right integrated-type earphones of which left and right output units are connected to each other, such as neckband-type earphones. Still further, the hearing apparatus 10 may be a portable speaker(s) that can be disposed around the user. The above-described devices and the like are merely examples, and the hearing apparatus 10 is not limited to these examples.

Further, the hearing apparatus 10 is not limited to those that users wear on both the left and right ears. The hearing apparatus 10 may be configured so that a user puts it on either the left or the right.

The hearing apparatus 10 includes a communication unit (not shown). The hearing apparatus 10 connects to a network (not shown) by using this communication unit. The network may be a wired or wireless network. This embodiment will be described by using an example in which the hearing apparatus 10 connects to a network through wireless communication. The communication unit is a module for communicating with a wireless device. The communication unit may be, for example, a communication interface based on short-range wireless communication standards such as Bluetooth (Registered Trademark), Wi-Fi (Registered Trademark), or infrared communication. The communication method of the communication unit is not limited to these examples. That is, the communication unit may perform communication by using any of various communication methods.

The wireless device may be, for example, a smartphone, a tablet terminal, a mobile phone terminal, or a PC (Personal Computer). The hearing apparatus 10 may display, for example, a display window for measuring the hearing level of a user or a display window for enabling a user to adjust the volume on a display unit of a smartphone. In this way, the user can easily measure the hearing level and adjust the volume. The configuration of the hearing apparatus 10 is not limited to this example. For example, the hearing apparatus 10 may be configured to perform measurement or the like without using any wireless device. Further, the wireless device may be an IC recorder or a music player. The hearing apparatus 10 can output sound signals from these wireless devices.

The hearing apparatus 10 includes a processor and a memory as a configuration not shown in the drawing. Further, as shown in FIG. 1, the hearing apparatus 10 includes the storage unit 19 as a storage device. In the storage unit 19, a computer program in which the processing according to this embodiment is implemented is stored. The processor can load the computer program from the storage unit 19 onto the memory and execute the loaded computer program. In this way, the processor implements the functions of the acquisition unit 11, the setting unit 12, the volume adjusting unit 13, the sound input unit 14, the sound output unit 15, the operation unit 16, and the storage unit 19.

Alternatively, each of the acquisition unit 11 and the like may be implemented by dedicated hardware. Further, some or all of the components of each unit may be implemented by general-purpose or dedicated circuitry, a processor, or a combination thereof. These components may be formed by a single computer chip or by a plurality of computer chips connected to each other through a bus. Some or all of the components of each unit may be implemented by a combination of the above-mentioned circuitry or the like and a program(s). Further, for the processor, a CPU (Central Processing Unit), a GPU (Graphics Processing Unit), an FPGA (Field-Programmable Gate Array), a quantum processor (quantum computer control chip), or the like may be used.

Further, in the case where some or all of the components of the hearing apparatus 10 are implemented by a plurality of information processing apparatuses, circuits, or the like, the plurality of information processing apparatuses, circuits, or the like may be disposed at one place in a concentrated manner or disposed over a plurality of places in a distributed manner. For example, the information processing apparatuses, circuits, or the like may be implemented as a client-server system, a cloud computing system, or the like, in which the components or the like are connected to each other through a communication network. Further, the functions of the hearing apparatus 10 may be provided in the form of Saas (Software as a Service).

### (Configuration of Hearing Apparatus 10)

Next, each of the components of the hearing apparatus 10 will be described. The acquisition unit 11 acquires the hearing level of a user. The hearing level of the user is information indicating the level of the hearing ability of the user. The hearing level can be associated with the hearing loss level of the user indicating the degree of hearing loss of the user.

The acquisition unit 11 acquires the hearing level of the user by performing, for example, a process for measuring the hearing level. An example of a measurement process performed by the acquisition unit 11 will be described hereinafter. The acquisition unit 11 makes the sound output unit 15 output a plurality of measurement sounds having different volumes, and measures the hearing level of the user according to the response from the user.

For example, the acquisition unit 11 makes a wireless device such as a smartphone described above display a predetermined display window on a display unit thereof, and performs a measurement process by using this display window. The user operates the wireless device according to the display window and inputs information necessary for the measurement process. In this way, the user can measure his/her hearing level by using the hearing apparatus 10 and the wireless device.

For example, the acquisition unit 11 displays a choice display area for receiving an input from the user in the display window. This choice display area may be, for example, a selection button on which text “Heard” or “Not heard” is shown. The choice display area is not limited to this example, and may be any of other forms as long as it is possible to receive a response from the user to the output measurement sound. For example, the choice display area may consist of, for example, an “OK” button and an “NG” button. The user operates the wireless device and makes a response in regard to whether he/she heard the measurement voice or did not hear it.

The acquisition unit 11 measures the hearing level by, for example, performing a binary tree search using a predetermined binary tree. This binary tree has a plurality of nodes to each of which a volume level of a measurement sound is associated. Further, the binary tree includes convergence points at which the binary tree converges. The convergence point is a node to which a volume level for determining the hearing level of the user is associated. The convergence point may be one indicating the minimum audible level of the user.

The acquisition unit 11 first outputs a first measurement sound having a volume level associated with the highest-level node in the binary tree. The user inputs either “Heard” or “Not heard” for the first measurement sound by using the selection button. The acquisition unit 11 proceeds to a lower-level node according to the response from the user to the first measurement sound and outputs a second measurement sound having a volume level associated with this lower-level node. The user responds to the second measurement sound in the same manner as the response to the first measurement sound. The acquisition unit 11 proceeds to a further lower-level node according to the response from the user to the second measurement sound and outputs a third measurement sound having a volume level associated with this lower-level node.

The acquisition unit 11 repeats the above-described processes, and thereby performs the binary tree search until the binary tree converges. When the acquisition unit 11 reaches the convergence point, it determines the hearing level of the user based on the volume level of the measurement sound associated with the convergence point. By performing the above-described processes, the acquisition unit 11 measures the hearing ability of the user in a predetermined measurement range. The predetermined measurement range may be a fixed range or a range that is changed as appropriate.

The measurement range can correspond to, for example, a range of volumes with which the sound output unit 15 can output a sound. The measurement range can be set by using, within the range of volumes with which the sound output unit 15 can output a sound, the maximum volume and the minimum volume. Note that the measurement range may be set to a range different from the range of volumes with which the sound output unit 15 can output a sound. For example, the measurement range may be set to a range narrower than the range of volumes with which the sound output unit 15 can output a sound.

By performing the measurement process described above, the acquisition unit 11 acquires the hearing level of the user according to the result of the binary tree search. Note that since the above-described measurement method is merely an example, the acquisition unit 11 may acquire a hearing level by using other methods. Further, the acquisition unit 11 may acquire, for example, a hearing level measured by an apparatus other than the hearing apparatus 10. Alternatively, a hearing level may be stored in the storage unit 19 in advance and the acquisition unit 11 may acquire the hearing level.

Further, the acquisition unit 11 determines the hearing loss level of the user based on the acquired hearing level. The hearing loss level indicates the degree of hearing loss of the user. This embodiment will be described by using five Hearing Loss Levels L1 to L5. Among the five hearing loss levels, Hearing Loss Level L1 indicates the lowest hearing loss level (slight hearing loss), and Hearing Loss Level L5 indicates the highest hearing loss level (serious hearing loss). Therefore, a user with Hearing Loss Level L1 has the best hearing ability, and a user with Hearing Loss Level L5 has the worst hearing ability. For example, Hearing Loss Levels L1 and L2 are hearing levels of people with normal hearing, and Hearing Loss Levels L3 to L5 are hearing levels of people with impaired hearing.

Note that although the hearing level is classified by using five hearing loss levels in this example, the classification method is not limited to this example. It is sufficient if the hearing loss level is divided into two or more levels.

The acquisition unit 11 determines the hearing loss level in such a manner that the higher the hearing level is, the lower the hearing loss level becomes. For example, the acquisition unit 11 divides the range of measurable hearing levels into five groups in advance according to the hearing level. For example, it is assumed that the acquisition unit 11 can measure the hearing level over a range of 40 levels. In this case, the acquisition unit 11 defines Groups 1 to 5 which are obtained by dividing the hearing levels into groups each of which includes eight levels. In the case where Groups 1 to 5 are defined in descending order of the hearing level, Groups 1 to 5 correspond to Hearing Loss Levels L1 to L5, respectively.

Based on the measured hearing level of the user, the acquisition unit 11 specifies a group to which the hearing level of the user belongs from Groups 1 to 5. In this way, the acquisition unit 11 determines the hearing loss level of the user corresponding to his/her hearing level. For example, when the acquisition unit 11 specifies that the hearing level of the user belongs to Group 1, it determines that the hearing loss level of the user is Level L1. Further, when the acquisition unit 11 specifies that the hearing level of the user belongs to Group 5, it determines that the hearing loss level of the user is Level L5. Note that since the above-described method is merely an example, the acquisition unit 11 may determine the hearing loss level by a method other than the above-described method.

The setting unit 12 sets a volume curve, which is used to adjust the volume, according to the hearing loss level (hearing level) of the user acquired by the acquisition unit 11. The volume curve is information representing a relationship between a plurality of volume steps and volume levels. Details of the volume curve will be described later.

The plurality of volume steps are set so that the volume level of the output sound can be changed in a stepwise manner in the hearing apparatus 10. The hearing apparatus 10 can adjust the volume over a range of a large number of steps by changing the output volume using the plurality of volume steps. The number of the plurality of volume steps defined within the range of volume levels at which the hearing apparatus 10 can output a sound is two or more. The user can select the volume level of the output sound by selecting one of the plurality of volume steps. When the output sound is not at the desired volume level, the user can adjust the volume by performing an operation for increasing or decreasing the volume step.

Further, the volume level is information indicating the volume of a sound output from the sound output unit 15. Each of the plurality of volume steps is associated with a volume level. The volume level may be set within the same range as the above-described measurement range, or may be set within a range different therefrom.

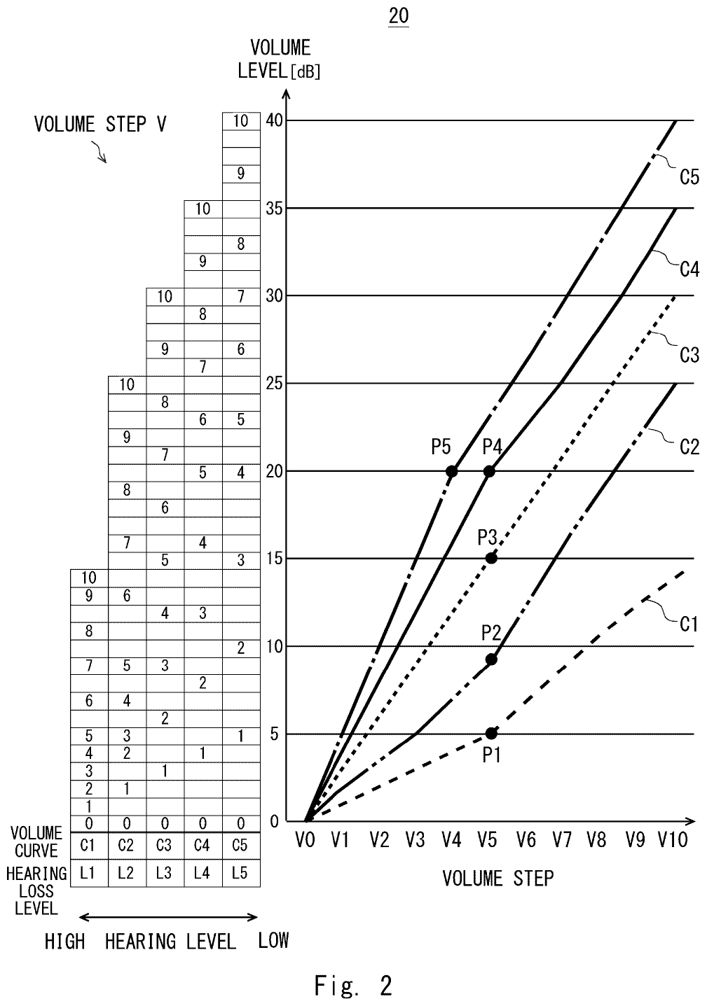

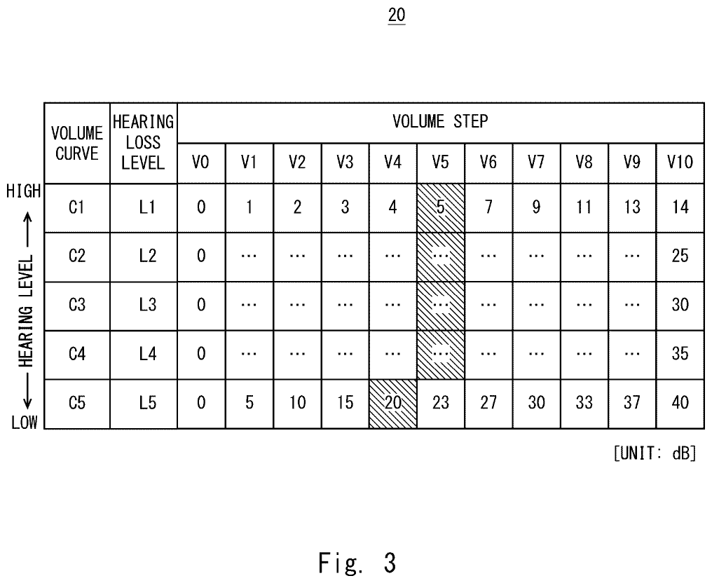

A volume curve according to this embodiment will be described hereinafter with reference to FIGS. 2 and 3. FIG. 2 shows an example of volume curve information 20 showing information about volume curves. Further, FIG. 3 shows the volume curve information 20 in a table format. The volume curve information 20 includes information about Volume Curves C1 to C5 each of which represents a relationship between a plurality of Volume Steps V0 to V10 and volume levels corresponding to the respective volume steps.

The setting unit 12 refers to the volume curve information 20 and selects one of Volume Curves C1 to C5 according to the hearing loss level of the user. For example, when the hearing loss level of the user is Level L1, the setting unit 12 selects Volume Curve C1. Further, when the hearing loss level is Level L5, the setting unit 12 selects Volume Curve C5.

In FIG. 2, the horizontal axis indicates volume steps that the user can select. Further, the vertical axis indicates volume levels corresponding to the volume steps. The volume curve information 20 can be stored in the storage unit 19 in advance by using a predetermined table like the one shown in FIG. 3. The hearing apparatus 10 may acquire volume curve information 20 from other apparatuses through a network.

Note that in this embodiment, for the sake of explanation, dots representing volume levels corresponding to respective volume steps are connected to one another by segments, so that the volume curves are shown by using segments as shown in FIG. 2. As shown in FIG. 3, these volume levels may be discrete values. Further, in the case where volume steps can be finely set, i.e., a large number of volume steps can be set, the volume curve may be defined in such a manner that a part of or the whole volume curve is expressed by a curve(s).

Volume Step V0 represents a volume step in a silent state. Therefore, at Volume Step V0, the volume level is 0 dB. Further, ten Volume Steps V1 to V10 are set as volume steps in a state where a sound is output. Different volume levels are respectively set in Volume Steps V1 to V10. Further, the volume levels are set so as to increase in the order of Volume Steps V1, V2, . . . , and V10. Therefore, when Volume Step V0 is included in the volume steps, the hearing apparatus 10 can adjust the output sound over a range of 11 steps. Note that the number of volume steps can be changed as appropriate.

In this embodiment, the maximum volume level at which the hearing apparatus 10 can output a sound is 40 dB. Therefore, the hearing apparatus 10 can output a sound having a volume level from 0 dB to 40 dB. The hearing apparatus 10 can set a part of this output range as a volume adjustment range according to the hearing level of the user. The adjustment range is a range which is set according to the hearing level and in which the volume can be adjusted. Note that the range of volume levels at which the hearing apparatus 10 can output a sound can be changed as appropriate.

The volume curve information 20 includes information showing Volume Curves C1 to C5 which are set according to the hearing loss level. Volume Curves C1 to C5 are volume curves corresponding to Hearing Loss Levels L1 to L5, respectively. The volume adjustment ranges of Volume Curves C1 to C5 differ from one another.

Note that a volume level indicating the lower limit of the adjustment range is referred to as a minimum volume, and a volume level indicating the upper limit thereof is referred to as a maximum volume. Volume Step V0 corresponds to the minimum volume, and Volume Step V10 corresponds to the maximum volume. The minimum volumes of Volume Curves C1 to C5 are all 0 dB. Meanwhile, Volume Curves C1 to C5 have maximum volumes different from one another. The maximum volume is set according to the hearing loss level. For example, the volume level corresponding to the maximum volume step may be set in such a manner that the lower the hearing level is, the higher the volume level becomes. Therefore, Volume Curves C1 to C5 have adjustment ranges different from one another.

For example, as shown in FIG. 3, the maximum volume of Volume Curve C1 is 14 dB, so the when Volume Curve C1 is used, the adjustment range is from 0 dB to 14 dB. Therefore, a user with Hearing Loss Level L1 adjusts the volume in the range from 0 dB to 14 dB. Meanwhile, the maximum volume of Volume Curve C5 is 40 dB, so that when Volume Curve C5 is used, the adjustment range is from 0 dB to dB. Therefore, a user with Hearing Loss Level L5 adjusts the volume in the range from 0 dB to 40 dB.

As described above, by setting a different adjustment range according to the hearing loss level, the hearing apparatus 10 can adjust the volume in an adjustment range that is determined according to the hearing level of the user. A user with a high hearing level can adjust the volume in a relatively narrow volume range including ten steps. Further, a user with a low hearing level can adjust the volume in a relatively wide volume range including ten steps.

Each of Volume Curves C1 to C5 has a change point at a predetermined position. In the example shown in FIG. 2, Volume Curves C1 to C5 have Change Points P1 to P5, respectively, at positions corresponding to Volume Step V4 or V5. Change Points P1 to P5 are points at which the inclinations of the respective Volume Curves C1 to C5 change. That is, Volume Curves C1 to C5 are defined so that the amounts of change in volume level before and after Change Points P1 to P5 are different from each other. Note that there may be a volume curve in which the inclinations before and after Change Point P3 are roughly equal to each other as in the case of Volume Curve C3. Further, in FIG. 3, the volume steps corresponding to Change Points P1 to P5 are indicated by shading.

Each of Change Points P1 to P5 can be set in an intermediate range located between the minimum step and the maximum step among the plurality of volume steps. In this embodiment, the minimum step is Volume Step V0, and the maximum step is Volume Step V10. For example, the intermediate range may be, when Volume Steps V0 to V10 are divided into three groups, i.e., a first part, a middle part, and a last part in ascending order of the volume, a range corresponding to the middle part. Note that the numbers of volume steps belonging to the three groups do not have to be equal to each other.

For example, assume that the first part of the volume steps consists of Volume Steps V0 to V3; the middle part consists of Volume Steps V4 to V6; and the last part consists of Volume Steps V7 to V10. In this case, Volume Steps V4 to V6 correspond to the intermediate range. Therefore, Volume Curves C1 to C5 are set so as to have Change Points P1 to P5, respectively, at positions corresponding to one of Volume Steps V4 to V6. In the example shown in FIG. 2, Volume Curves C1 to C4 have Change Points P1 to P4, respectively, at the positions corresponding to Volume Step V5. Further, Volume Curve C5 has Change Point P5 at the position corresponding to Volume Step V4.

Further, the intermediate range may be a range that is centered at the volume step located at the center of Volume Steps V0 to V10 and includes two volume steps before and after that volume step. For example, the volume step located at the center of Volume Steps V0 to V10 is Volume Step V5. Therefore, for example, Volume Steps V4 to V6, i.e., Volume Step V5 and two steps before and after Volume Step V5, may be defined as the intermediate range.

Further, the intermediate range may be, when Volume Steps V0 to V10 are divided into two parts, i.e., a first half and a second half, a range including the boundary position therebetween. For example, assume that Volume Steps V0 to V10 are divided into a first half consisting of Volume Steps V0 to V5 and a second half consisting of Volume Steps V6 to V10. In this case, Volume Steps V5 and V6 correspond to the boundary between the first and second halves. Therefore, the range including Volume Steps V5 and V6 may be set as the intermediate range. Since the above-described method for setting an intermediate range is merely an example, the intermediate range may be set by using other methods.

Each of Change Points P1 to P5 is set at any position within the above-described intermediate range on the volume curve. For example, each of Change Points P1 to P5 is set at a position corresponding to a volume step at or near the center among the volume steps included in the intermediate range. In this way, on Volume Curves C to C5, Change Points P1 to P5 can be set at Volume Step V4 or V5 which is located at or near the center of the intermediate range. The positions of Change Points P1 to P5 are not limited to these examples. That is, each of Change Points P1 to P5 may be set at a position corresponding to a volume step corresponding to the lowest volume or a volume step corresponding to the highest volume among the volume steps included in the intermediate range.

Note that Change Points P1 to P5 may be set without setting the intermediate range. For example, each of Change Points P1 to P5 may be set so as to correspond to a volume step located at the center among Volume Steps V0 to V10. In this embodiment, the volume step located at the center of Volume Steps V0 to V10 is Volume Step V5. Therefore, Volume Curves C1 to C5 may be defined so as to have Change Points P1 to P5, respectively, at Volume Step V5.

Further, as shown in FIG. 2, each of Volume Curves C1 to C5 is defined in such a manner that: the lower the hearing level is, the gentler the inclination after the change point, i.e., the respective one of Change Points P1 to P5, than the inclination before the change point becomes; and the higher the hearing level is, the steeper the inclination after the change point, i.e., the respective one of Change Points P1 to P5, than the inclination before the change point becomes. Note that the expression “before Change Points P1 to P5” means a range in which the volume is lower than the volume at the change point, i.e., the respective one of Change Points P1 to P5. Further, the expression “after Change Points P1 to P5” means a range in which the volume is higher than the volume at the change point, i.e., the respective one of Change Points P1 to P5.

In the example shown in FIG. 2, the hearing level decreases in the order of Volume Curves C1, C2, . . . , and C5. As shown in the drawing, in Volume Curve C5 of which the hearing level is the lowest, the inclination after Change Point P5 is gentler than the inclination before Change Point P5. Similarly, in Volume Curve C4, the inclination after Change Point P4 is gentler than the inclination before Change Point P4. In Volume Curve C3, the inclinations before and after Change Point P3 are roughly equal to each other. In Volume Curve C2, the inclination after Change Point P2 is steeper than the inclination before Change Point P2. Further, in Volume Curve C1 of which the hearing level is the highest, the inclination after Change Point P1 is steeper than the inclination before Change Point P1 as in the case of Volume Curve C2. In this way, it is possible to set Volume Curves C1 to C5 according to the hearing level of the user.

For example, a user with Hearing Loss Level L1 has a good hearing ability, so it is possible for him/her to easily adjust the volume by a small number of operations if sounds having low volumes can be adjusted more finely than sounds having high volumes can be. Therefore, in the example shown in FIG. 2, Volume Curve C1 is set so that the inclination before Change Point P1 is gentler than the inclination thereafter. Further, a user with Hearing Loss Level L5 has a poor hearing ability, so it is possible for him/her to easily adjust the volume by a small number of operations if sounds having high volumes can be adjusted more finely than sounds having low volumes can be. Therefore, in the example shown in FIG. 2, Volume Curve C5 is set so that the inclination after Change Point P5 is gentler than the inclination therebefore.

In other words, Volume Curves C1 to C5 are set so that the discrete intervals between the volume steps before and after Change Points P1 to P5, respectively, are different from one another according to the corresponding hearing level. The discrete interval between volume steps indicates the magnitude of the change in the volume level when the volume step is changed by one step. For example, the larger the discrete interval between volume steps is, the larger the change in the volume level when the volume step is raised or lowered by one step becomes.

As shown in FIGS. 2 and 3, Volume Curves C1 to C5 are set in such a manner that the lower the hearing level is, the more the discrete intervals before Change Points P1 to P5, respectively, become wider than the discrete intervals after Change Points P1 to P5, respectively. For example, in Volume Curve C1 of which the hearing level is the highest, the discrete interval is 1 dB in the range of Volume Steps V0 to V5 before Change Point P1. Further, the discrete interval is roughly 2 dB in the range of Volume Steps V5 to V10 after Change Point P1. In contrast, in Volume Curve C5 of which the hearing level the lowest, the discrete interval is 5 dB in the range of Volume Steps V0 to V4 before Change Point P5. Further, the discrete interval is 3 dB or 4 dB in the range of Volume Steps V4 to V10 after Change Point P5.

Therefore, for example, in the case where a user with Hearing Loss Level L1 increases the volume level one step at a time from Volume Steps V0 to V5, the volume level changes at narrow intervals, such as 0 dB, 1 dB, 2 dB, 3 dB, 4 dB, and 5 dB. In contrast, when a user with Hearing Loss Level L5 increases the volume level from Volume Steps V0 to V5, the volume level changes at wide intervals, such as 0 dB, 5 dB, 10 dB, 15 dB, and 20 dB.

Further, when a user with Hearing Loss Level L1 increases the volume level one step at a time from Volume Steps V5 to V10, the volume level changes at wider intervals than those in Volume Steps V0 to V5, such as 5 dB, 7 dB, 9 dB, 11 dB, 13 dB, and 14 dB. In contrast, when a user with Hearing Loss Level L5 increases the volume level one step at a time from Volume Steps V5 to V10, the volume level changes at narrower intervals than those in Volume Steps V0 to V5, such as 23 dB, 27 dB, 30 dB, 33 dB, 37 dB, and 40 dB.

As described above, by setting Volume Curves C1 to C5 in such a manner that the inclinations before and after Change Points P1 to P5, respectively, are different from each other according to the hearing level (so that the discrete intervals of the volume steps are different from one another), the hearing apparatus 10 can adjust the volume according to the hearing level (hearing loss level) of the user. For example, in comparison with the case where the volume is uniformly adjusted over a wide range from 0 dB to 40 dB as in the related art described above, the hearing apparatus 10 can reduce the magnitude of the change in the volume level per one step according to the hearing level of the user.

Note that the setting unit 12 may set volume curves corresponding to the left and right ears, respectively. In this case, the acquisition unit 11 measures the hearing level of each of the right and left ears. The setting unit 12 sets each of a volume curve for the left ear and that for the right ear. In this way, even when the hearing levels of the right and left ears are different from each other, the setting unit 12 can set volume curves according to the hearing levels of the right and left ears, respectively. In this way, the hearing apparatus can adjust the volumes according to the right and left ears, respectively, of the user.

Note that in the case where the hearing levels of the right and left ears are measured together, or either of the right and left ears is measured, the setting unit 12 may set a common volume curve for the right and left ears. Further, even when the hearing levels of both the right and left ears are measured, the setting unit 12 may set a common volume curve for the right and left ears by using either of the measured hearing levels.

Further, after setting the volume curve, the setting unit 12 may set the volume curve again. For example, there may be cases where the volume curve set in the past does not fit to the current hearing level of the user due to changes in his/her physical conditions or because his/her hearing ability has declined. In such a case, the user may feel that the output sound is too loud or too small, or have a difficulty in using the hearing apparatus or the like. By having the acquisition unit 11 acquire or measure the hearing level again, and having the setting unit 12 set the volume curve again, it is possible to adjust the volume according to the current state of the user. The setting unit 12 may perform the re-setting every predetermined period, or may perform the re-setting upon receiving an input from the user.

Volume Curves C1 to C5 shown in FIGS. 2 and 3 are merely examples of volume curves according to the present disclosure, so they may be changed as appropriate. For example, Volume Curves C1 to C5 may be set in such a manner that they have different inclinations according to the hearing level before Change Points P1 to P5, respectively, and have the same inclinations irrespective of the hearing level after Change Points P1 to P5, respectively.

Further, for example, Volume Curves C1 to C5 may be set in such a manner that the inclinations are steeper before Change Points P1 to P5 than those after Change Points P1 to P5. Further, contrary to the above description, each of Volume Curves C1 to C5 is defined in such a manner that: the lower the hearing level is, the steeper the inclination after the change point than the inclination before the change point becomes; and the higher the hearing level is, the gentler the inclination after the change point than the inclination before the change point becomes.

Further, although the example in which the setting unit 12 sets Volume Curves C1 to C5 by referring to the volume curve information expressed by a predetermined table has been described in the above description, the present disclosure is not limited to this example. The setting unit 12 may set the volume curve by using, for example, a trained model generated by using, for example, AI (Artificial Intelligence) with deep learning introduced therein. For example, the trained model is trained so that it receives the hearing level of a user and outputs a volume curve. The setting unit 12 inputs the hearing level of a user acquired by the acquisition unit 11 to the trained model, acquires an output result therefrom, and sets a volume curve based thereon.

The description is continued by referring to FIG. 1 again. The volume adjusting unit 13 controls the sound output unit 15 according to an operation performed on the operation unit 16 by a user. When an operation for raising or lowering the volume is performed, the volume adjusting unit 13 adjusts the volume level of an output sound based on the volume curve set by the setting unit 12.

The volume adjusting unit 13 adjusts the volume level of an output sound by, for example, amplifying or attenuating a sound signal corresponding to sounds collected by the sound input unit 14. The volume adjusting unit 13 makes the sound output unit 15 output the adjusted sound signal. In this way, the volume adjusting unit 13 adjusts the volume so that the user can hear the sound at a desired volume. Note that the output sound may be one that is based on a sound signal received from a wireless device connected to the hearing apparatus 10.

The sound input unit 14 is an input device that collects sounds occurring therearound and acquires them as a sound signal. The sound input unit 14 is, for example, a microphone. The sound input unit 14 acquires, for example, voices of a person with whom the user is in conversation or ambient sounds occurring around the user. The sound input unit 14 converts the collected sounds into a sound signal and outputs the sound signal to the volume adjusting unit 13.

The sound output unit 15 is an output device that outputs sounds under the control of the volume adjusting unit 13. The sound output unit 15 outputs sounds based on, for example, a sound signal received from a wireless device connected to the hearing apparatus 10 or a sound signal corresponding to sounds collected by the sound input unit 14. The sound output unit 15 is, for example, a speaker. The sound output unit 15 may include a bone conduction-type speaker or the like.

The operation unit 16 is an input device that receives an input from a user. The operation unit 16 is, for example, an operation button(s) by which the user can set various operations for the hearing apparatus 10. When the user operates the operation button, the operation unit 16 receives an input from the user. The operation button can be configured so that a user or the like can input different types of information by changing, for example, the number of times of pressing, the position of pressing, or the direction of pressing. The hearing apparatus 10 performs an assigned operation in response to the pressing of the operation button.

For example, the operation unit 16 receives a volume adjustment request for adjusting the volume level according to the number of times, the pressing position, or the pressing direction of the operation button. In this way, the user can adjust the volume by switching the volume level so that the output sound has a desired volume level.

The operation button may include a button for increasing the volume and a button for decreasing the volume. The operation unit 16 receives a volume adjustment request in response to the pressing of one of the buttons. The operation button(s) may be provided only in one of the left and right output units or may be provided in each of them. In the case where the operation button(s) is provided only in one of separate-type left and right output units, information about an operation performed on the operation button provided in the one output unit may be transferred to the other output unit. Further, when an operation button(s) is provided in each of the left and right output units, operations to be performed by the hearing apparatus 10, assigned to these operation buttons may be different from each other. Further, the left and right output units may be configured so that their volumes are adjusted independently of each other.

The operation button(s) may be a physical operation button(s) or a virtual operation button(s) such as a touch sensor. The operation unit 16 may include a plurality of such operation buttons. Since the operation button(s) described above is merely an example of the operation unit 16, the operation unit 16 may be implemented by using other structures or the like. For example, the operation unit 16 may include a microphone for collecting voices of a user and receive an operation performed by the user through a voice input. Further, the operation unit 16 may also be configured so as to display a display window for adjusting the volume on a display screen provided in a wireless device such as a smartphone, and receive an input from the wireless device.

The storage unit 19 is a storage device in which a program for implementing each function of the hearing apparatus 10 is stored. Further, the volume curve information 20 described above is also stored in the storage unit 19.

### (Processing Performed by Hearing Apparatus 10)

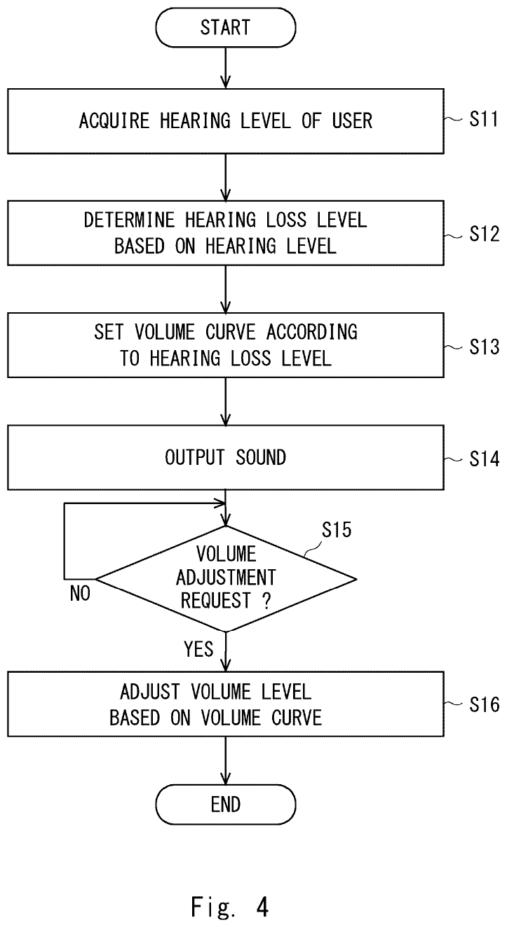

Next, processes performed by the hearing apparatus 10 according to this embodiment will be described with reference to FIG. 4. FIG. 4 is a flowchart showing a control process performed by the hearing apparatus 10 according to this embodiment. Further, the following description will be given by referring to FIGS. 2 and 3 as appropriate. Firstly, the acquisition unit 11 acquires the hearing level of a user (S11). The acquisition unit 11 acquires the hearing level by, for example, performing a process for measuring the hearing level. For example, the acquisition unit 11 makes the sound output unit 15 output a plurality of measurement sounds having different volumes, and measures the hearing level by performing a binary tree search using a predetermined binary tree. The method for acquiring a hearing level is not limited to this example, and the acquisition unit 11 may acquire the hearing level of a user by using other methods. Alternatively, the acquisition unit 11 may acquire a hearing level measured by an apparatus other than the hearing apparatus 10.

Next, the acquisition unit 11 determines the hearing loss level of the user based on his/her hearing level (S12). The acquisition unit 11 determines the hearing loss level corresponding to the hearing level by, for example, referring to volume curve information 20 like the one shown in FIGS. 2 and 3. In this embodiment, five Hearing Loss Levels L1 to L5 are set.

Next, the setting unit 12 sets a volume curve according to the determined hearing loss level (S13). In this embodiment, the volume curve information 20 includes five types of Volume Curves C1 to C5. The setting unit 12 selects one of Volume Curves C1 to C5 that corresponds to the hearing loss level of the user. For example, when the hearing loss level of the user is Level L1, the setting unit 12 selects Volume Curve C1.

As described above, Volume Curves C1 to C5 represent relationships between Volume Steps V0 to V10 and the volume levels of sounds outputs at the respective volume steps. In this embodiment, Volume Step V0, which corresponds to a silent state, and ten Volume Steps V1 to V10, which correspond to non-silent states, are set as the volume steps. The number of volume steps may be changed as appropriate.

Further, as described above with reference to FIGS. 2 and 3, Volume Curves C1 to C5 have Change Points P1 to P5, respectively, at predetermined positions, and are defined so that the inclinations before and after the change points are different from each other. Change Points P1 to P5 are set in an intermediate range located between Volume Step V0, which is the minimum volume step, and Volume Step V10, which is the maximum volume step. For example, Change Point P1 of Volume Curve C1 is set at Volume Step V5, which is located at the center between Volume Steps V0 and V10.

Further, each of Volume Curves C1 to C5 is defined in such a manner that: the lower the hearing level is, the gentler the inclination after the change point, i.e., the respective one of Change Points P1 to P5, than the inclination before the change point becomes; and the higher the hearing level is, the steeper the inclination after the change point, i.e., the respective one of Change Points P1 to P5, than the inclination before the change point becomes. For example, in Volume Curve C5 of which the hearing level is the lowest, the inclination after Change Point P5 is gentler than the inclination before Change Point P5. Further, in Volume Curve C1 of which the hearing level is the highest, the inclination after Change Point P1 is steeper than the inclination before Change Point P1.

The volume adjusting unit 13 controls the sound output unit 15 so as to output a sound (S14). The sound is, for example, one that is obtained by amplifying voices in a conversation carried on around the user, collected by the sound input unit 14. The volume adjusting unit 13 can output the sound at an arbitrary volume level. For example, the volume adjusting unit 13 can be configured so as to output a sound at a volume step in an intermediate range on the set volume curve. In this way, the volume adjusting unit 13 can set a default volume level according to the hearing level of the user and output a sound at the set default volume level.

Next, the volume adjusting unit 13 determines whether or not there is a volume adjustment request from the user (S15). When there is no volume adjustment request (No in S15), the volume adjusting unit 13 waits until a volume adjustment request is issued. When there is a volume adjustment request (Yes in S15), the volume adjusting unit 13 adjusts the volume level based on the volume curve (S16). Note that when there are multiple volume adjustment requests, the volume adjusting unit 13 adjusts the volume level corresponding to the number of such requests. In this way, the user can adjust the volume level so that the output sound has a desired volume level.

Note that the hearing apparatus 10 can perform the above-described processes for each of the left and right ears. Specifically, the acquisition unit 11 acquires the hearing levels corresponding to the left and right ears respectively (S11) and determines the hearing loss levels thereof respectively (S12). The setting unit 12 sets the volume curves corresponding to the left and right ears respectively (S13). The volume adjusting unit 13 controls the sound output unit 15 so as to output left and right sounds (S14). The volume adjusting unit 13 determines whether or not there is a volume adjustment request from the user (S15), and when there is no volume adjustment request (No in S15), it waits until a volume adjustment request is issued. Further, when there is a volume adjustment request (Yes in S15), the volume adjusting unit 13 adjusts the left and right volume levels based on the volume curves corresponding to the left and right ears respectively (S16).

Further, after setting the volume curve, the hearing apparatus 10 may re-set the volume curve again in the above-described processes. For example, in the step S13, the setting unit 12 stores, in the storage unit 19, information about the date and time when the volume curve was set. The setting unit 12 determines whether or not a predetermined period has elapsed since the volume curve was set the last time. Then, when the setting unit 12 determines that the predetermined period has elapsed, it re-sets the volume curve. For example, the setting unit 12 makes the acquisition unit 11 acquire the hearing level again. The setting unit 12 may make the acquisition unit 11 acquire the hearing level again by making it measure the hearing level again. The setting unit 12 re-sets the volume curve according to the newly-acquired hearing level. In this way, the setting unit 12 can update the volume curve. The method for updating the volume curve is not limited to this example, and the setting unit 12 may re-set the volume curve when requested by a user. In this way, the hearing apparatus 10 can adjust the volume according to the current hearing level of the user.

As described above, the hearing apparatus according to this embodiment acquires the hearing level of a user, and sets a volume curve representing a relationship between a plurality of volume steps and volume levels according to the acquired hearing level of the user. The volume curve has a change point at a predetermined position, and is defined in such a manner that the inclinations of the volume curve before and after the change point are different from each other. The hearing apparatus adjusts the volume level of the output sound based on the volume curve.

In this way, even when a predetermined number of volume steps are specified in advance, the volume can be adjusted in a volume range effective for the user. For example, when ten volume steps are set in advance, a user with a high hearing level can adjust the volume over a range of ten volume steps by using an adjustment range including relatively low volume levels. Further, a user with a low hearing level can adjust the volume over a range of ten steps by using an adjustment range including relatively high volume levels as well.

As described above, a user can adjust the volume in a range of volume levels that is determined according to his/her own hearing level. In this way, even when users having widely different hearing levels use the hearing apparatus according to this embodiment, it is possible to prevent the change in volume per one step from becoming too large or too small. Therefore, according to the hearing apparatus according to this embodiment, the volume can be adjusted according to the hearing level of a user.

Note that each of the functional components of the above-described hearing apparatus 10 can be implemented by hardware that implements the functional component (e.g., a hardwired electronic circuit or the like) or by a combination of hardware and software (e.g., a combination of an electronic circuit and a program for controlling it or the like). For example, the present disclosure may also be implemented by causing a CPU (Central Processing Unit) to execute a computer program.

In the above-described examples, the program includes a set of instructions (or software codes) that, when read into a computer, causes the computer to perform one or more of the functions described in the example embodiments. The program may be stored in a non-transitory computer readable medium or in a tangible storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (Registered Trademark) disc or other optical disc storages, a magnetic cassette, magnetic tape, and a magnetic disc storage or other magnetic storage devices. The program may be transmitted on various types of transitory computer readable media or communication media. By way of example rather than limitation, transitory computer readable media or communication media may include electrical, optical, acoustic, or other forms of propagation signals.

The present disclosure is not limited to the above embodiments, and they may be modified as appropriate without departing from the scope and spirit of the disclosure.

The hearing apparatus, the control method, and the program according to an embodiment of the present disclosure can adjust a volume according to the hearing level of a user.

The present disclosure can be applied to a hearing apparatus or the like that can adjust a volume.

What is claimed is:

1. A hearing apparatus capable of adjusting a volume level of an output sound by using a plurality of volume steps, comprising:
an acquisition unit configured to acquire a hearing level of a user;
a setting unit configured to set a volume curve representing a relationship between the plurality of volume steps and the volume level according to the hearing level; and
a volume adjusting unit configured to adjust the volume level based on the volume curve, wherein
the volume curve has a change point at a predetermined position and is defined in such a manner that inclinations of the volume curve before and after the change point are different from each other.

2. The hearing apparatus according to claim 1, wherein the change point is set in an intermediate range located between a minimum volume step and a maximum volume step among the plurality of volume steps.

3. The hearing apparatus according to claim 1, wherein the volume curve is defined in such a manner that: the lower the hearing level is, the gentler an inclination after the change point than an inclination before the change point becomes; and the higher the hearing level is, the steeper the inclination after the change point than the inclination before the change point becomes.

4. The hearing apparatus according to claim 1, wherein the setting unit sets the volume curve for each of a left ear and a right ear.

5. The hearing apparatus according to claim 1, wherein the acquisition unit measures the hearing level by performing a binary tree search using a binary tree having a plurality of nodes with each of which a volume level of a measurement sound is associated, and acquires the hearing level of the user based on the volume level of the measurement sound associated with a convergence point of the binary tree search.

6. The hearing apparatus according to claim 1, wherein
a plurality of volume curves having ranges for adjusting for the volume level different from one another are defined, and
the setting unit sets one of the plurality of volume curves according to the hearing level of the user.

7. The hearing apparatus according to claim 1, further comprising a storage unit configured to store information about a date and time when the volume curve is set, wherein
the setting unit determines whether or not a predetermined period has elapsed since the volume curve was set the last time, and when the setting unit determines that the predetermined period has elapsed, the setting unit makes the acquisition unit acquire the hearing level again and re-sets the volume curve according to the newly-acquired hearing level.

8. A method for controlling a hearing apparatus capable of adjusting a volume level of an output sound by using a plurality of volume steps, comprising:
an acquisition step of acquiring a hearing level of a user;
a setting step of setting a volume curve representing a relationship between the plurality of volume steps and the volume level according to the hearing level; and
a volume adjusting step of adjusting the volume level based on the volume curve, wherein
the volume curve has a change point at a predetermined position and is defined in such a manner that inclinations of the volume curve before and after the change point are different from each other.

9. A non-transitory computer readable medium storing a program for causing a computer to perform a method for controlling a hearing apparatus capable of adjusting a volume level of an output sound by using a plurality of volume steps, the method for controlling the hearing apparatus comprising:
an acquisition step of acquiring a hearing level of a user;
a setting step of setting a volume curve representing a relationship between the plurality of volume steps and the volume level according to the hearing level; and
a volume adjusting step of adjusting the volume level based on the volume curve, wherein
the volume curve has a change point at a predetermined position and is defined in such a manner that inclinations of the volume curve before and after the change point are different from each other.
